(19) United States
(12) Patent Application Publication
(10) Pub. No.: US 2002/0077975 A1
(43) Pub. Date: Jun. 20, 2002

(54) Call cycle setting device and call cycle setting method for use in call sales

(75) Inventor: Kenji Tsumura, Saga-ken (JP)

Correspondence Address: JORDAN AND HAMBURG LLP, 122 EAST 42ND STREET, SUITE 4000, NEW YORK, NY, 10168, US

(73) Assignee: Kentop Corporation, Saga-shi (JP)

(21) Appl. No.: 09/915,741

(22) Filed: Jul. 26, 2001

(30) Foreign Application Priority Data
Aug. 8, 2000 (JP) 2000-240311

(51) Int. Cl. G06F 17/60

(52) U.S. Cl. 705/39; 705/2

(57) ABSTRACT

An appropriate call cycle is set without relying on the intuition or experience of a salesperson. Proposed call cycles that have been set in advance are stored in a storage means 12. An input means 11 inputs the amount of products consumed when calling on a customer and stores this in the storage means 12. An increase/decrease calculation means 13 acquires a past consumed amount and the current consumed amount from the consumed amount stored in the storage means 12 and calculates the rate of increase or decrease in the current consumed amount compared to the past consumed amount. This is then stored in the storage means 12. The call cycle setting means 14 acquires the rate of increase or decrease from the storage means 12 and sets a call cycle corresponding to the rate of increase or decrease selected from the proposed call cycles stored in the storage means 12. The output means 15 outputs the set call cycle.

### BACKGROUND OF THE INVENTION

1. Field of the Invention

The present invention relates to a call cycle setting device and a call cycle setting method for setting a cycle at which a customer is called, i.e., a call cycle in the field of call sales of medical supplies and various other products.

2. Description of the Related Art

In the field of call (i.e. door-to-door) sales of medical supplies and the like, conventionally, a system has been used in which a medicine chest containing several types of medicines having various beneficial effects is delivered and consigned to a customer. After an appropriate time has passed, a call sales operator (referred to below as a “salesperson”) visits the customer and receives payment from the customer for those medicines that the customer has used from the medicine chest and also replenishes the supplies of the used medicines.

In this type of system, what is known as the consigned medicine data, which comprises the medicines kept by the customer and the medicinal items and numerical quantities thereof used by the customer and the like, has conventionally been recorded in an account book known as an order estimate book. However, recently, methods of recording and management using computers have become increasingly widespread.

On the other hand, because the management of the medicines in the medicine chest kept by the customer has been entrusted to the salesperson who visits the customer, the various management tasks relating to the types of medicines, the numerical quantities thereof, the limits on the time they are left with the customer, and so on, have all been performed by the individual salespersons. When he or she visits the customer, each salesperson sets the call cycle for calling on the customer according to various data relating to the customer that is based on the salesperson's experience.

The call cycle is the cycle at which the replenishment of and payment for products such as medicines and the like are carried out. As there is a limit on the amount of products that can be left with the customer, if the set call cycle is too long, some products may run out. Since call sales employ what is known as a “use-now-pay-later” business system (i.e. the customer pays later for the amount used), the maximum amount of sales possible for each call is the amount of the product left with the customer, and sales opportunities may be lost if the products ran out well before the next visit.

If, on the other hand, the call cycle is set to be short, the amount of the remaining product with the customer can be frequently checked, and no sales opportunities are lost. However, if a short call cycle is set for the customer who does not consume a large amount of products, then the profits do not increase while the calling costs do increase.

For theses reasons, a short call cycle needs to be set for a customer who consumes a large amount of products while a long call cycle should be set for a customer who uses a small amount of products. However, the experience and intuition of the salesperson play a vital part in deciding the call cycle for a customer.

### SUMMARY OF THE INVENTION

Therefore, in the present invention, there are provided a call cycle setting device and a call cycle setting method for use in call sales that enable an appropriate call cycle to be set without depending on the intuition and experience of the salesperson.

According to the present invention, the call cycle setting device for setting a cycle for calling on a customer in the field of call sales in which a product is sold by being delivered and consigned to the customer comprises: first storage means for storing proposed call cycles that have been set in advance; means for inputting a consumed amount of the product when calling on the customer; second storage means for storing the input consumed amount; means for acquiring a current consumed amount and a past consumed amount from the second storage means and calculating a rate of increase or decrease in the current consumed amount compared to the past consumed amount; third storage means for storing the calculated rate of increase or decrease; means for acquiring both the rate of increase or decrease from the third storage means and the proposed call cycles from the first storage means and setting the call cycle corresponding to the rate of increase or decrease; and means for outputting the set call cycle.

In addition, in the call cycle setting method of the present invention for setting a cycle for calling on a customer in the field of call sales in which a product is sold by being delivered and consigned to the customer, proposed call cycles that have been set in advance are stored; a consumed amount of the product is input and stored when calling on the customer; a current consumed amount and a past consumed amount are acquired from the stored consumed amount and a rate of increase or decrease in the current consumed amount compared to the past consumed amount is calculated and stored; the stored rate of increase or decrease is acquired and a call cycle corresponding to the rate of increase or decrease is selected from the stored proposed call cycles and set; and the set call cycle is output.

According to the above inventions, each time a customer is visited, the next call cycle is selected from proposed call cycles and set, and amore appropriate call cycle that corresponds to the increase or decrease in the consumed amount is obtained based on the increase or decrease in the current consumed amount relative to past consumed amount.

The amount of products consumed by each customer may be input directly from a personal computer or portable input/output terminal. It is also possible to input indirectly by transferring the consumed amount that is calculated based on the input data of the stock of the product held by the customer and the numerical quantity to be consigned. Similarly, the value of the call cycle may be input directly, or indirectly by transferring a value generated automatically using a schedule generating device or the like.

### BRIEF DESCRIPTION OF THE DRAWINGS

FIG. 1 is a schematic view of a stock management system in an embodiment of the present invention.

FIG. 2 is a block diagram showing call cycle setting functions of a host computer.

FIG. 3 is a flow chart showing the processing of the stock management system in the present embodiment.

FIG. 4 is an explanatory diagram showing the rule for setting the call cycle using rates of increase or decrease.

### DESCRIPTION OF THE PREFERRED EMBODIMENTS

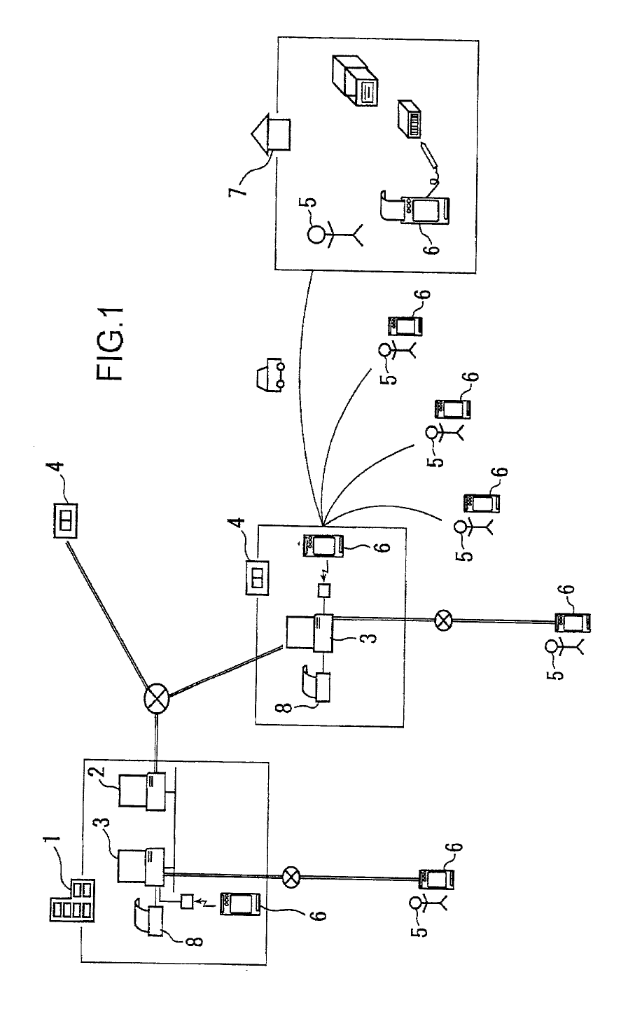

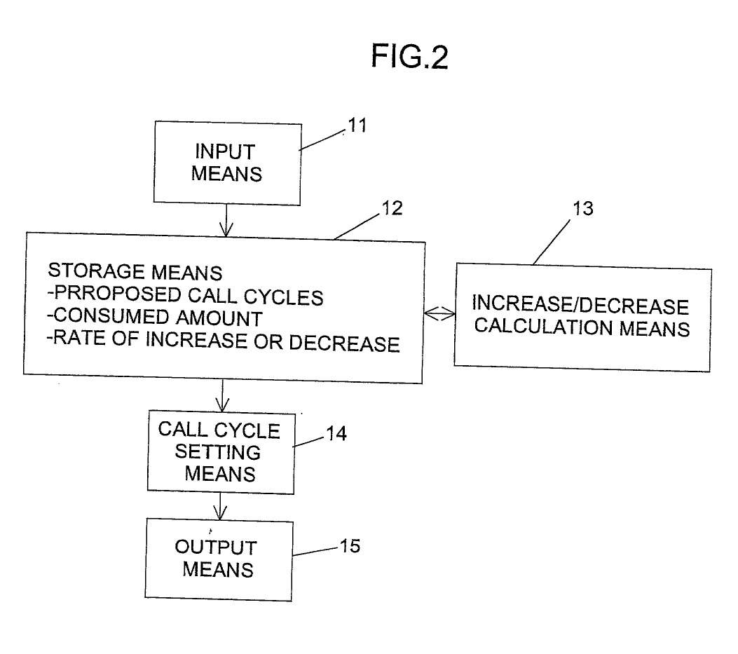

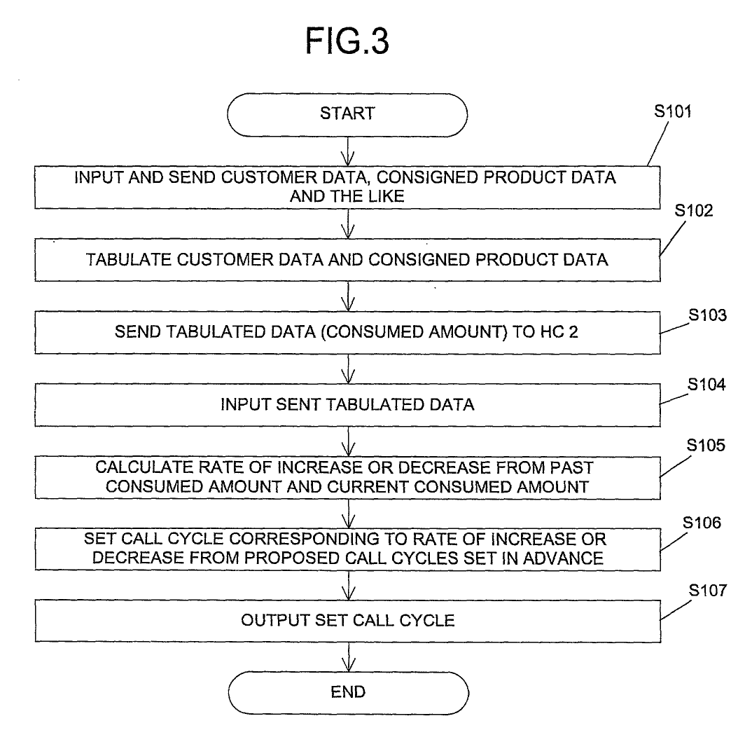

FIG. 1 is a schematic view of a stock management system in an embodiment of the present invention; FIG. 2 is a block diagram showing call cycle setting functions of a host computer shown in FIG. 1; and FIG. 3 is a flow chart showing the processing of the stock management system in the present embodiment.

As is shown in FIG. 1, a host computer (referred to below as “HC”) 2 for data tabulation analysis and a personal computer (referred to below as “PC”) 3 connected to the host computer 2 for data communication are installed in a head office 1. The PC 3 is also installed in each sales office 4 and each sales person 5 carries a portable input/output terminal (referred to below as “HT”) 6.

The salesperson 5 inputs and records on the HT 6 all data relating to a customer 7 as the client such as data on the customer and data on the products consigned to the customer. Tabulation analysis is performed when the customer data and consigned product data recorded in the HT 6 is sent to the PC 3. At this time, a telephone line, infrared communication, a PC card, or the like may be used for the means of communication between the HT 6 and the PC 3, and a data file is transferred using these means.

The customer data includes an area code, the customer's name and address, the call cycle, the date of the last call, the days when the customer stays, the times when the customer stays, a residential map page, the previous credit balance, a record of the sales, the total sales amount, the amount recovered, the current credit balance, the date of the next payment collection, a clinical history, and the like. The consigned product data includes product names, regular prices of the products, product efficacy, names of the manufacturers, selling prices, discount, customer stock, limits on the time the product is left with the customer, consigned product items, consigned product quantity instructions, salesperson stock items, salesperson stock numerical quantities, limits on expiry dates, total prices, and the like.

The salesperson 5 calls on the customer in accordance with the call cycle of each customer. When the task of calling on the customer 7 is ended, the salesperson 5 sends the customer data and consigned product data input into the HT 6 to the PC 3 (step S101). Note that the transmission of that day's transaction data from the HT 6 to the PC 3 may be performed while the salesperson 5 is out on call and the salesperson 5 can send data directly to the PC 3 by PC communication using a telephone line from the HT 6 carried by the salesperson 5. The customer data and consigned product data sent to the PC 3 are tabulated by the PC 3 (step S102) and the tabulated data is sent to the HC 2 (step S103).

In FIG. 2, the HC 2 is provided with input means 11 for inputting tabulated data sent from the PC 3, storage means 12 for storing the input tabulated data and calculation results and the like, an increase/decrease rate calculation means 13 for calculating the rate of increase or decrease of a consumed amount, a call cycle setting means 14 for setting a call cycle based on the data acquired from the storage means 12, and an output means 15 for outputting the results of the calculations and the like to the PC 3 and a printer 8.

The tabulated data sent from the PC 3 is input using the input means 11 and stored in the storage means 12 (step S104). As shown in Table 1, the tabulated data stored in the storage means 12 includes the amount of a consumed product (i.e. the sales). In this embodiment, the amount of a consumed product is the amount consumed per day which is obtained by dividing the amount of products which has been consumed in one call cycle by the number of days of the call cycle.

TABLE 1

| CONSUMED AMOUNT PER | |
|---|---|
| DAY BETWEEN THE | CONSUMED AMOUNT |
| LAST CALL AND THE | PER DAY BETWEEN THE LAST |
| CALL BEFORE LAST | CALL AND THE CURRENT CALL |
| 4 | 6 |

As shown in Table 1, proposed call cycles are stored in advance in the storage means 12. The proposed call cycles shown in Table 2 are the seven call cycles which are frequently used in the field of medicine call sales and comprise cycle A, B, C, D, E, F and G in sequence from the shortest period to the longest.

TABLE 2

| CYCLE | PERIOD |
|---|---|
| A | 1 MONTH |
| B | 2 MONTHS |
| C | 3 MONTHS |
| D | 4 MONTHS |
| E | 5 MONTHS |
| F | 6 MONTHS |
| G | 12 MONTHS |

The increase/decrease rate calculation means 13 acquires the past consumed amount stored in the storage means 12, namely, the amount consumed per day in the period from the call before last to the last call and the current consumed amount, namely, the amount consumed per day in the period from the last call to the current call, and calculates the rate of increase or decrease in the current consumed amount compared to the past consumed amount using the following formula (step S105).

Rate of increase or decrease=current consumed amount/past consumed amount −1.0.

For example, if the rate of increase or decrease is calculated from Table 1, the result is 5/4−1=0.25. The rate of increase or decrease calculated in this manner by the increase/decrease rate calculation means 13 is stored in the storage means 12.

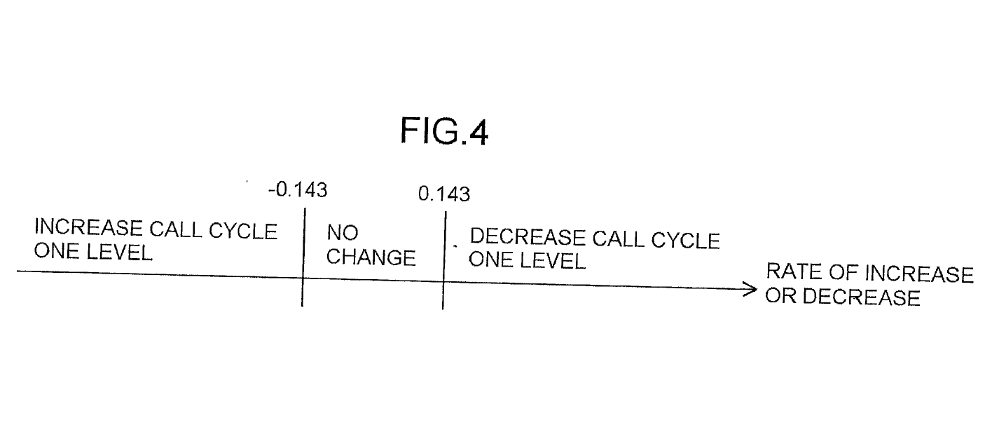

The call cycle setting means 14 acquires the rate of increase or decrease stored in the storage means 12 and select a call cycle corresponding to this rate of increase or decrease from the proposed call cycles stored in the storage means 12 (step S106). In the present embodiment, since there are provided in advance seven proposed call cycles A to G in sequence from the cycle having the shortest period to the cycle having the longest period, the call cycle is set using 1 divided by 7 (≈0.143) as the standard. If the rate of increase or decrease calculated by the increase/decrease rate calculation means 13 is equal to or more than 0.143, then the call cycle is set to be the one having the next shortest period. If the rate of increase or decrease is equal to or less than −0.143, the call cycle is set to be the one having the next longest period. If the rate of increase or decrease is between −0.143 and 0.143, the call cycle is left the same without being altered at all. FIG. 4 shows the rule for setting the call cycle using the rate of increase or decrease. Accordingly, in the example shown in Table 1, if the call cycle for the current call is D, then the call cycle until the next call is set to be the cycle C which has the next shortest period.

In the present embodiment, based on the tabulated data stored in the storage means 12, if the sales for the amount consumed in the period from the last call to the current call are less than the cost caused by a single call, the call cycle is not altered even if the rate of increase or decrease is 0.143 or more. Thus, it is possible to prevent the cost of the call from exceeding the profit from a customer who has a comparatively long call cycle and consumes an extremely small amount of products by shortening the call cycle.

The call cycle that has been set in this manner is output using an output means 17 (step S107). The output call cycle is not based upon the intuition and experience of the salesperson, but is a more appropriate one that corresponds to the increase or decrease in the consumed amount. It is also possible to prevent failure in sales opportunities and products from running out. Consequently, the amount of products remaining with a customer can be closely checked, thereby increasing profits.

While the preferred form of the present invention has been described, it is to be understood that modifications will be apparent to those skilled in the art without departing from the spirit of the invention. The scope of the invention, therefore, is to be determined solely by the following claims.

What is claimed is:

1. A call cycle setting device for setting a cycle for calling on a customer in the field of call sales in which a product is sold by being delivered and consigned to the customer, comprising:
first storage means for storing proposed call cycles that have been set in advance;
means for inputting a consumed amount of the product when calling on the customer;
second storage means for storing the input consumed amount;
means for acquiring a current consumed amount and a past consumed amount from the second storage means and calculating a rate of increase or decrease in the current consumed amount compared to the past consumed amount;
third storage means for storing the calculated rate of increase or decrease;
means for acquiring both the rate of increase or decrease from the third storage means and the proposed call cycles from the first storage means and setting the call cycle corresponding to the rate of increase or decrease; and
means for outputting the set call cycle.

2. A call cycle setting method for setting a cycle for calling on a customer in the field of call sales in which a product is sold by being delivered and consigned to the customer, wherein:
proposed call cycles that have been set in advance are stored;
an amount of the product that has been consumed is input and stored when calling on the customer;
a current consumed amount and a past consumed amount are acquired from the stored consumed amount and a rate of increase or decrease in the current amount consumed compared to the past consumed amount is calculated and stored;
the stored rate of increase or decrease is acquired and a call cycle corresponding to the rate of increase or decrease is selected from the proposed stored call cycles and set; and
the set call cycle is output.
